(19) United States
(12) Patent Application Publication
(10) Pub. No.: US 2003/0221877 A1
(43) Pub. Date: Dec. 4, 2003

(54) Configurable keys for pen-based devices

(75) Inventor: Edward Ralph Harrison, Beaverton, OR (US)

Correspondence Address: Julie L. Reed, MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/163,180

(22) Filed: Jun. 3, 2002

(51) Int. Cl. G06K 11/06

(52) U.S. Cl. 178/18.01

(57) ABSTRACT

A device has the capability of performing applications. The device comprises a processor to execute applications. It includes a display screen and a case housing the display screen. The device includes at least one button on the case, wherein the button performs a different function depending upon an application being executed.

### BACKGROUND

1. Field

This disclosure relates to pen-based devices, more particularly to configurable keys on portable, pen-based devices.

2. Background

Pen-based devices may stand alone or be linked to another device, such as a removable, pen-based device linked to a docking station or host device by a cable, infrared, wireless or other link. These devices have many conveniences, including their portability, but have some shortcomings.

For example, a user wants to employ an application on the pen-based device that requires a set of frequent operations. The user employs a web browser, where frequent operations may include page forward, page back and scrolling. For word processing applications, these may include page up, page down, and functions that place the cursor at the beginning or end of the line, such as ‘home’ and ‘end.’ A pen-based device requires that the user let go of the device with one hand, take up a stylus and then touch the screen with the stylus to direct the device to perform these operations, every time these operations are desired.

### BRIEF DESCRIPTION OF THE DRAWINGS

The invention may be best understood by reading the disclosure with reference to the drawings, wherein:

FIG. 1 shows an embodiment of a pen-based device having configurable keys.

FIG. 2 shows an embodiment of a pen-based device attached to a host system.

FIG. 3 shows a flowchart of an embodiment of a method to configure keys on a pen-based device.

FIG. 4 shows a flowchart of an embodiment of a method for user configuration of keys on a pen-based device.

### DETAILED DESCRIPTION OF THE EMBODIMENTS

Pen-based computers reduce the need for a keyboard and thus have moved towards having as few as keys as possible for form factor and design simplicity reasons. However, in instances where a set of operations is performed frequently, keys on the bezel of ‘face plate’ of the devices may be useful. However, newer pen-based devices may be able to employ several different applications, each of which has it's own set of frequently used operations. Rather than placing an excessive number of buttons on the bezel, one for each application function, these keys can be reused in order to effectively employ the fewest number of keys.

In one example, each key on the bezel could have a fixed function, such as on devices where a menu displayed by the device has text associated with each button that is displayed to the user. The user knows that this button performs a predetermined function each time it is pressed. In another example, the user may configure the buttons. This is similar to some applications where the user may define ‘shortcut’ keys on a keyboard of a computing device to allow frequent operations to be performed without having to dig down through several levels of menus.

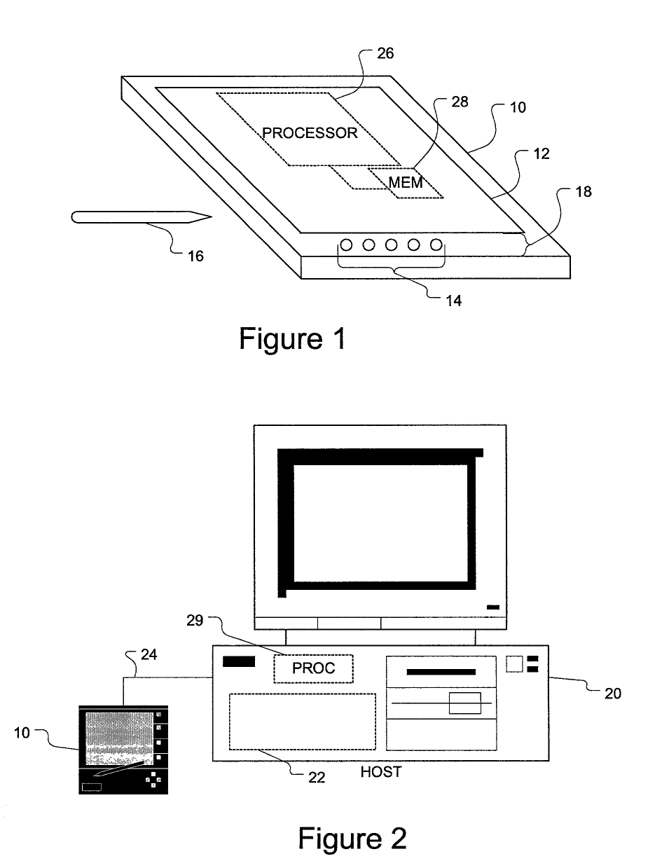

In one embodiment, a pen-based computing device has buttons on the bezel, where the key functions are changed depending upon the application the user is focusing on. An example of such a device is shown in FIG. 1. The device 10 generally includes a display 12. In some embodiments this display further comprises a touch-sensitive screen. When the user desires to select an option presented on the screen, the user touches that option with a stylus 16. The processor 26 then receives the signal indicating the user selection and executes the necessary instructions to perform that selection.

Examples of this type of device include the Intel® Web Tablet by Intel Corporation, and the Mira™ technology soon to be offered by Microsoft® Corporation. The Intel® WebTablet allowed users to access the World Wide Web, or Internet, via a portable device that connected to a host through a wireless network. The host would make connection to the Internet, and act as an intermediary between the Intel® WebTablet and the Internet. Devices based on the Mira™ technology may perform functions more akin to a laptop computer, being able to run many different applications

The Intel® WebTablet for example, was designed primarily as a web browsing device and therefore had a high level of integration between the device as web-related functions, such as ‘page forward’ and ‘page back.’ Therefore, it was relatively simple to integrate those functions into the hardware and provide buttons with fixed functions. However, more recent pen-based devices such as Mira™ technology have many more capabilities. This prevents a tight integration because most of these newer devices can run any application and there is no current means to track which button means which function in each application.

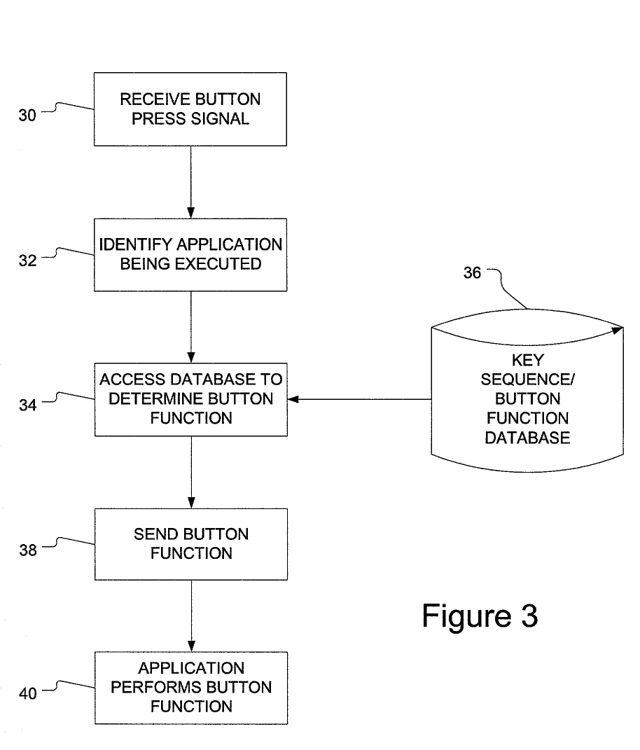

Referring back to FIG. 1, however, the processor 26 may have the capability of determining the proper key sequence that should occur when a button is pressed. The buttons 14 will typically reside on the bezel 18, which is the portion of the device case surrounding the display. However, they may be located anywhere on the device case. The memory 28 may include a database of key sequences, also referred to as button functions. When the button is pressed, the processor may access the memory to determine the correct button function for the active application. The memory then sends the processor the correct function and the processor performs that function within the application. This will be discussed in more detail with reference to FIG. 3.

The application within which the button function is performed is whichever application the device is ‘focusing’ on or executing. In an environment in which there may be open several windows, the active window is the one in which the user is operating. For example, a user may have a spreadsheet in a first window, a word processor in a second window and a game in the third window. The user may be working on a document in the word processor at the time the user pushes a button. In this example, the word processing application would be the active application, or the application being executed.

The application may be executed directly by the processor 26 of the pen-based device of FIG. 1. However, the application may also be executed by a host system and the processor is ‘executing’ that application based upon signals from the host system. An example of a host system is shown in FIG. 2. The host system 20 may comprises a personal computer, to which a cable 24 attaches the pen-based device 10. Alternatively, the pen-based device 10 may insert into the host system by a docking bay 22.

In this last example, the host system 20 would function as a docking station. For example, the host system may have a link to a network such as the Internet, and the pen-based device 10 is coupled to the host system 20 by a wireless link. The user can then have the advantages of a network link without the encumbrance of a phone line. Alternatively, the host system could have a local link to the pen-based device, allowing the user access to all of the applications on the host system without the encumbrance of a full-size personal computer or the need to synchronize between the two devices.

The processor on the pen-based device or a processor on the host system may execute the application being executed. Similarly, the memory accessed to determine the proper button function for the application being executed may reside as memory 28 on device 10 of FIG. 1, or memory 29 of the host system. However, for speed and efficiency, the memory will more than likely reside on the pen-based device.

The access of the memory will also more than likely involve accessing a database. An embodiment of a method to determine button functions is shown in FIG. 3. At 30, the processor receives a button press signal. The processor then identifies which application is active at 32. At 34, a database 36 is accessed to determine the button function. The determination is based upon the application being executed and which button, if there is more than one possibility, was pressed. The memory then sends the button function to the processor at 40, which then may perform the button function at 40.

It should be noted that receiving the button press signal at 30 and performing the button function at 40 might be optional. The processor may store the key sequence button function when the application becomes active and access it as necessary. Similarly, the user may have pressed another button after the first button signal and the processor may skip the first signal to process the second button function.

For example, the user has several windows open and is currently operating in the web browser, and is operating in the Windows® environment. The user presses one of the buttons on the device. The processor receives the signal indicating that the button has been pressed. The processor then accesses the database and determines that for the web browser, the button press has been designated as the ‘back’ button. The memory sends the Alt+Left Arrow key sequence to the processor. The processor then runs the SendInput application programming interface (API), and performs the proper key sequence for the button function and the browser performs a back function. This is just one example of a specific implementation, not intended to limit the scope of the invention in any way.

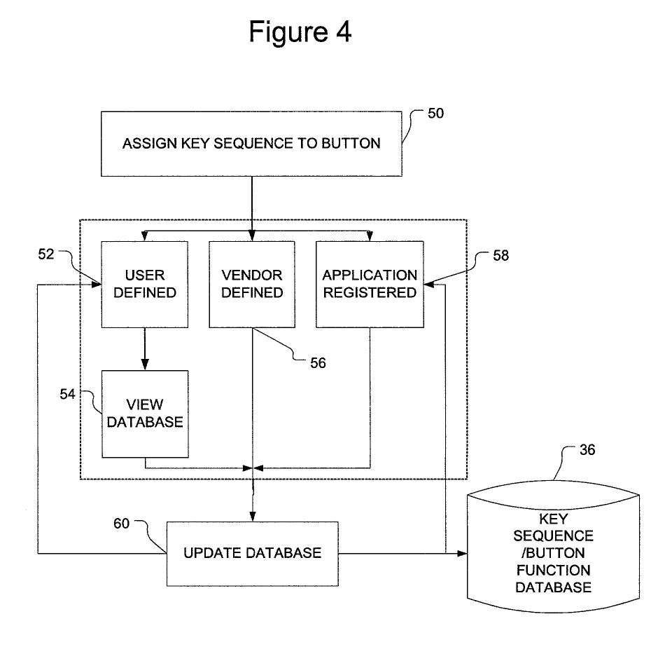

The user may then switch to using a word processing application, such as MS Word®. When the user changes windows, and focuses on the word processing application, the button may then map to the ‘BOLD’ function that renders the typeface in bold face. The user has a wide range of selections from which the key mapping sequence may be drawn. The user may customize or configure the key sequence database. An example of such a process is shown in FIG. 4.

The key sequence database 36 may be originally provided by the vendor of the pen-based device, whether that provision is directly from the vendor or from a partner. For example, a Mira™ tablet may be provided by Microsoft® with a key sequence database provided by Microsoft®, or a database provided by a different company. In either case, this will be defined as a vendor configured database. Initially, the key sequence is assigned to a button at 50 by the key sequence database 36.

The user may make the initial assignment at 52. Alternatively, the database may be vendor-defined at 56. In yet another alternative, applications can register their shortcuts with the database upon their execution, causing the database to be populated by application registration at 58. The database is then updated at 60.

After the initial configuration, the user can assign keys and view the database by returning to the processes 52 and 54 and causing the database to be updated again at 60. Alternatively, as new applications are installed or executed, the applications register their key sequences at 58 and the database is updated at 60. In this manner the database is user-configurable, applications can register their key sequences and provide shortcuts, or the database can remain as provided by the vendor, all up to the user's discretion.

Thus, although there has been described to this point a particular embodiment for a method and apparatus for configuring keys on a pen-based device, it is not intended that such specific references be considered as limitations upon the scope of this invention except in-so-far as set forth in the following claims.

What is claimed is:

1. A device, comprising;
a processor to execute application;
a display screen;
a case housing the display screen; and
at least one button disposed upon the case, wherein the button performing a different function depending upon an application being executed.

2. The device of claim 1, wherein the device further comprises a stylus.

3. The device of claim 1, wherein the display further comprises a touch-sensitive screen.

4. The device of claim 1, wherein the device further comprises a memory.

5. The memory of claim 4, wherein the memory is to store a database of functions.

6. The device of claim 1, wherein the processor is also to access a database of a button functions when the button is pressed.

7. A system, comprising:
a host device to execute application;
a removable device, electrically coupled to the host device; and
at least one button on the removable device, wherein the button has a different function depending upon an application being executed.

8. The system of claim 7, wherein the host device further comprises a personal computer.

9. The system of claim 7, wherein the host device further comprises a docking station.

10. The system of claim 7, wherein the application being executed includes a connection between the host device and a network.

11. The system of claim 7, wherein the removable device is a pen-based device.

12. A method of configuring button functions, the method comprising:
identifying an application being executed;
accessing a database to determine at least one button function for the application; and
sending the button function to the application.

13. The method of claim 12, wherein the method further comprises receiving a signal indicating that a button has been pressed.

14. The method of claim 12, wherein the method further comprises performing the button function.

15. The method of claim 12, wherein accessing a database further comprising accessing a database stored on the device.

16. The method of claim 12, wherein accessing a database further comprising accessing a database stored on a host device.

17. The method of claim 12, wherein sending the button function further comprises using an application programming interface.

18. An article of machine-readable code that, when executed, causes the machine to:
identify an application being executed;
access a database to determine at least one button function for the application; and
send the button function to the application.

19. The machine-readable code further causes the machine to receive a signal indicating that a button has been pressed.

20. The machine-readable code further causes the machine to perform the button function.

21. A method of configuring keys on a portable device, the method comprising:
assigning a key sequence to a button on a portable device; and
updating a key sequence database to reflect the key sequence.

22. The method of claim 21, wherein assigning a key sequence further comprises assigning user-defined key sequences.

23. The method of claim 21, wherein assigning a key sequence further comprises assigning vendor-assigned key sequences.

24. The method of claim 21, wherein assigning a key sequence further comprises registering key sequences from applications.
